(19) United States
(12) Patent Application Publication
(10) Pub. No.: US 2006/0216203 A1
(43) Pub. Date: Sep. 28, 2006

(54) Multiwell sample plate with integrated impedance electrodes and connection scheme

(75) Inventors: Chris K. Fuller, Oakland, CA (US); Jeffrey H. Sugarman, Los Altos, CA (US)

Correspondence Address: Kelvan P. Howard, Suite 200, 1170 Veteran's Blvd., South San Francisco, CA, 94080, US

(73) Assignee: MDS Sciex (US) a division of MDS Pharma Services (US) Inc., South San Francisco, CA (US)

(21) Appl. No.: 11/091,065

(22) Filed: Mar. 28, 2005

(51) Int. Cl. B01L 3/00

(52) U.S. Cl. 422/82.01; 422/102

(57) ABSTRACT

As disclosed within, the present device is directed to a multi-well sample module having integrated impedance measuring electrodes (which allow for the generation of an electric field within each well and the measuring of the change in impedance of each of the well's contents) and an electrical connection scheme allowing simultaneous measurement of each well's change in impedance.

### FIELD OF THE INVENTION

The present device relates to screening devices for label-free, real-time detection of cellular activation.

With the advent of combinatorial library methods for generating large libraries of compounds as well as improvements in miniaturization and automation of chemical and biological experiments, there has been a growing interest in methods for screening such libraries for binding with molecular targets, either in the presence or absence of the biological (cellular) environment.

HTS Methods

The most widely used screening method involves competitive or non-competitive binding of library compounds to a selected target protein, such as an antibody or receptor utilizing labeled agonists. This method is often conducted in a high throughput screening apparatus consisting of a multi-well device defining a plurality of discrete micro-wells on a substrate surface and measuring structures in each well. A variety of techniques have been developed for increasing assay throughput. The use of multi-well assay plates allows for the parallel processing and analysis of multiple samples distributed in multiple wells of a plate. Typically, samples and reagents are stored, processed and/or analyzed in multi-well assay plates (also known as microplates or microtiter plates). Analysis typically consists of optical or radiometric measurements of samples in each well. The microtiter plate typically acts as a container for the assay contents. Often, the surface of the plate will be treated so that it is more or less amenable to binding with one or more of the assay components. Alternatively (and much less common), the microtiter plate may be incorporated with structures, such as electrodes in each well that allow different measurements to be performed.

Various Electrode Structures

A number of electrode structures have been used with microwell plates. U.S. Patent application No. 20020025575 incorporates a pair of electrodes adapted for insertion into a well and circuitry for applying a low-voltage, AC signal across the electrodes when they (the electrodes) are submerged in the test sample. Synchronous measurement of the current across the electrodes allows monitoring of the level of growth or metabolic activity in the test compound. Because the insertion of an electrode structure into each plate well adds an additional level of complexity to the high throughput process and reduces throughput speed, integrated electrodes were needed. A substrate defining a plurality of discrete microwells where electrode pins that are attached to a multi-electrode cover plate are dipped into the liquid when the cover is placed over the substrate.

Cady et al. in U.S. Pat. No. 4,072,578 disclose a microtiter plate-based array of chambers with detectors for measurement of bacteria. The described devices have electrodes that protrude perpendicularly from the plate bottom surface. Protruding electrodes measure the bulk of the fluid in the microwell and do not allow for the measurement of a deposition of a layer of cells upon the electrodes. Giaver et al. in U.S. Pat. No. 5,187,096 teach a system for measuring cell impedance that utilizes a working and reference electrodes structure as well as multiple electrode layers and insulation layers. Connections to this device to the impedance measuring system are made via probes contacting the top surface of the edge of the electrode plate.

Van der Weide et al., in U.S. Pat. No. 6,649,402, claim a microplate with electrodes coupled together through the wells to allow the measurement of the capacitance or resistance or both between the electrodes at each well, with the change in the capacitance or resistance in each well over time being correlated with the extent of bacterial growth in a growth medium. Probes introduced from the top and electrodes on the bottom of the plate form the detecting device.

Several microplates have incorporated active, reference, and counter electrodes in their structures in order to detect changes in pH (acidification), ionic strength, or reduction/oxidation (redox) potential. Tsukuda et al. in European Patent Application EP 1136819 discuss a microplate with a plurality of cells where each cell has two electrodes formed at the bottom of each well, but Tsukuda's oxygen detection electrode structure requires the use of an active electrode, a counter-electrode, and a reference electrode structure. Purvis in UK Patent Application GB2386949 claims a multiwell plate for electrochemical analysis of the response of whole cells to changes in pH, ionic strength, or chemical composition of an electrolyte solution where the plate comprises a plurality of wells, with at least one of the wells having a sensing electrode and a reference electrode associated with it, and optionally a further counter electrode. Because redox reactions are traditionally conducted using direct voltage and the current flow associated with redox reactions would upset the electrochemical equilibrium of any cellular system, the integrated redox electrode structure cannot be used for systems that seek to monitor real-time cellular activation.

Analytical measurement devices utilizing electrochemiluminescence (ECL) also incorporate active, reference, and counter electrodes, as well as ECL reagents which are usually immobilized on the working electrode and a system to measure the luminescence generated from the reaction that takes place when the ECL reagent is energized, as with U.S. patent application No. 20040022677 (assignee Meso Scale Technologies).

Need for a Novel Technology

Along with the advantages of electrical testing in multiwell plates, one of the challenges that emerges is the large number of electrical contacts required as the number of wells increases. If there are two electrical contacts required per well, then a 96 well plate requires 192 electrical contacts, a 384 well plate requires 768 electrical contacts, and a 1536 well plate requires 3072 electrical contacts. Though in some applications the number of required electrical contacts may be reduced by connecting one or more conductors together (for instance, electrodes sharing a common ground line), there are applications in which this is not desired due to potential interferences between wells sharing connected conductors and the reduction in capability to simultaneously measure multiple wells. For small numbers of required electrical connections, the electrodes in the wells may be connected to electrical lines leading to the edge of the microtiter plate where edge-type connectors may be employed. For the larger number of required electrical connections, edge connections become inconvenient. In this case, using the entire surface area on the bottom of the microtiter plate is desired.

What is needed is an inexpensive, disposable, mass produce-able device that allows high information measurement and integrated addressable electrodes that allow measurement of the cellular impedance response of cellular populations when alternating voltage is applied across the electrodes. The device should work without signal amplification or disruption of the cellular electrochemical equilibrium. The device should work in a microtitre format that is easy to fabricate and compatible with common microplate laboratory automation systems. The needed device should greatly increase the available surface for making multiple electrical connections, allowing more wells to be precisely and simultaneously measured.

### SUMMARY OF THE INVENTION

The device relates to sample modules (preferably sample plates, more preferably multi-well sample plates) and apparatuses for conducting sample measurements. Sample modules of the device may include one or more, preferably a plurality, of wells, chambers and/or sample regions for conducting one or more sample measurements where the samples may include components that are liquid, solid, cellular, or biological compounds. The terms wells, chambers, and sample regions are defined as being interchangeable for this device. Preferably, these wells, chambers and/or sample regions comprise one or more electrical conductors for measuring the impedance of the sample in contact with the conductors.

The multi-well sample plates may include several elements, for example, an upper plate with a plurality of through holes, a bottom plate, wells or chambers, functionally equivalent conductors, dielectric materials, electrical connections, means for plate identification, and sample reagents. The wells of the plates may be defined by through holes or openings in the top plate. The bottom plate can be sealingly affixed to the top plate (either directly or in combination with other components) and can serve as the bottom of the well. The multi-well sample plates may have any number of wells or chambers of any size or shape, arranged in any pattern or configuration, and can be composed of a variety of different materials. For convenience, some standards have appeared for instrumentation used to process samples for high throughput assays. Preferred embodiments of the device use industry standard formats for the number, size, shape and configuration of the plate and wells.

Multi-well assay plates typically are made in standard sizes and shapes and having standard arrangements of wells. Some well established arrangements of wells include those found on 96-well plates, 384-well plates and 1536-well plates and 9600-well plates, with the wells configured in two-dimensional arrays. Other formats may include single well plates (preferably having a plurality of assay domains), 2 well plates, 6 well plates, 24 well plates, and 6144 well plates. The Society for Biomolecular Screening has published recommended standard microplate specifications for a variety of plate formats (see, http://www.sbs-online.org), the recommended specifications hereby incorporated by reference. Assays carried out in standardized plate formats can take advantage of readily available equipment for storing and moving the assay plates as well as readily available equipment for rapidly dispensing liquids in and out of the plates.

According the device, a plurality of functionally equivalent conductors in the form of impedance-measuring electrodes are incorporated into the wells. The present device describes several novel configurations and materials for conductors in multi-well assay plates and these conductors' connections to an associated impedance measurement system. Multi-well assay plates of the present device are designed for a single use and are well suited to applications where the plates are disposable. In some embodiments, a well of a multi-well plate may include a plurality of domains.

The device relates to processes that involve the use of functionally equivalent conductors in the form of impedance-measuring electrodes and the measurement of current, including the assay plate apparatus and methods of use for such processes. The device further relates to an apparatus that can be used to induce and/or measure current, for example, at the functionally equivalent conductors. Another aspect of the device relates to methods for performing assays comprising measuring impedance from an assay plate. Yet another aspect of the device relates to assay plates and plate components (e.g., plate bottoms, plate tops, and multi-well plates).

### DESCRIPTION OF THE FIGURES

FIG. 1. Illustration of an embodiment of the multi-well assay plate having 96 wells and a pair of functionally equivalent conductors in the form of impedance-measuring electrodes within each well.

FIG. 2. Illustration of an upper-plate with through holes before being sealingly affixed to a bottom-plate.

FIG. 3. Illustration of a top view of an impedance measuring electrode area from a bottom plate according to a preferred embodiment of the device

FIG. 4. Illustration of various conductor configurations

FIG. 5 Illustration of an expanded view of a side cross-section of one embodiment of one microwell

FIG. 6 Illustration of one embodiment of the electrode-electric contact pad connection configuration

FIG. 7. Illustration of the direct electrical connection made between the bottom surface of the impedance measuring electrodes and the contact pin of an associated measurement system found in an alternative embodiment of the device

FIG. 8. Illustrates the current signal received by a detector and the associated impedance generated by wells from a preferred embodiment of the multi-well assay plate of the present device.

FIG. 9. 96 kinetic impedance plots from the 96 wells of a specific embodiment of the inventive device (particularly, the plate of Example 1.) are generated simultaneously during a cell activation experiment.

FIG. 10. Graph of maximum impedance for each well of FIG. 9 from a specific embodiment of the inventive device (particularly, the plate of Example 1.) as a function of antagonist concentration to determine the IC₅₀ of each antagonist. The graph displays the plate architecture's ability to determine the relative potencies of the different antagonists

FIG. 11. 96 kinetic graphs of impedance measurements from the 96 wells of a specific embodiment of the inventive device (particularly, the plate of Example 2

FIG. 12. Histogram comparing the magnitude of the impedance responses from each of the compounds in the wells of a specific embodiment of the inventive device (particularly, the plate of Example 2.).

FIG. 13. 96 kinetic graphs of impedance measurements from the 96 wells of a specific embodiment of the inventive device (particularly, the plate of Example 3).

### DETAILED DESCRIPTION OF THE DEVICE

The device includes instrumentation and methods for conducting a variety of different types of measurements. The device includes assay plates, plate components, and methods for performing impedance-based cellular assays. The present device describes several novel configurations and/or materials for functionally equivalent conductors in assay plates, particularly in multi-well assay plates.

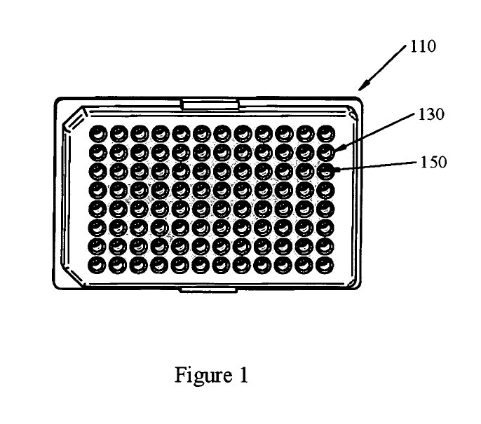

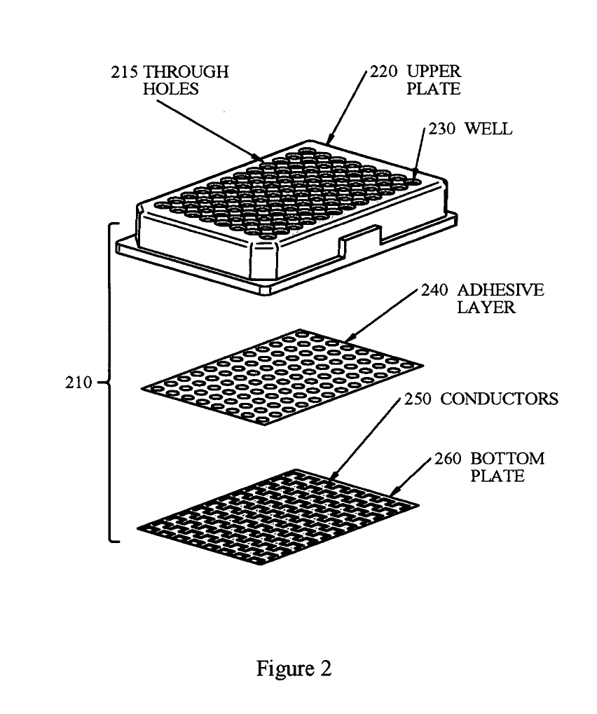

As shown in FIG. 1, the device relates to a single well or multi-well plate 110 for conducting one or more assays, the plate being formed from an upper plate and a bottom plate, and the assay plate having a plurality of wells 130 (and/or chambers) and a pair of functionally equivalent conductors 150 within each well or chamber. According to one embodiment of the device 210 (displayed in FIG. 2), the upper plate 220 is a unitary molded structure made from rigid thermoplastic material such as polystyrene, polyethylene, polypropylene, polycarbonate, or any other plastic that can be injection molded, machined, or otherwise fabricated into the desired configuration. The bottom-plate 260 is made from polyethylene terephthalate (also commonly known as mylar or PET), polyimide, polycarbonate, polystyrene, or cyclo-olefin polymer (COP). In an alternative embodiment, the upper-plate 220 and bottom-plate 260 material may comprise a combination of plastics and may comprise a plastic mixed with high impact polystyrene to reduce the brittleness of the material. Alternatively the upper 220 and bottom plates 260 may be formed from any material that can be molded into an appropriate shape. Materials such as plastics, elastomers, ceramics, composites, glass, carbon materials, or the like can be used. The upper-plate 220 and bottom-plate 260 are preferably formed from a material that is generally impervious to reagents typically encountered in biological assays, resistant to the adsorption of biomolecules, impervious to water and to organic solvents that are typically used to dissolve chemical libraries, and can withstand modest levels of heat. The upper-plate 220 and bottom-plate 260 are additionally made from a material that is sufficiently inexpensive to allow the devices to be disposed after one use, without large economic or ecological impacts.

The bottom plate 260 can be etched in a plasma-containing chamber in order to clean the surface of contaminants and in order to modify the normally hydrophobic substrate material. This treatment is known to enhance the attachment and viability of certain cell types and is used commonly in disposable laboratory plastics where cell growth is desired.

Flatness of the upper plate 220 is required so that the plate 210, when introduced into the assay system, can be effectively temperature controlled. The microplate 210 is pressed against the temperature control surface throughout the assay in order to maintain constant the temperature of the well contents. The temperature control surface may be a flat block of aluminum with holes through which the electronic connection pins of an associated impedance measurement system protrude. Alternatively, in order to enhance the contact between the microplate 210 and the temperature control surface, a compliant thermally conductive layer may be included between the temperature control surface and the device

Temperature control of the assays, typically between room temperature and 37 degrees Celsius (or 42 degrees Celsius for insect cells), is important for two reasons. Firstly, the cell activation assays performed in the devices are quantified using impedance difference before and after chemical compounds are introduced to the cells. Non-specific changes in the impedance due to changes in the temperature of the buffer or cells during the assay would negatively impact the precision measurements that are desired. Secondly, it is known that biological activity of all types, from simple molecular interactions to complex cellular signaling pathways, can be sensitive to changes in temperature. For these responses, temperature control of the devices during the assays are important, and controlling to within 1 degree of a set-point, or alternatively 0.5 degrees, or further to within 0.1 degrees, is desired.

Although the plates may be of any thickness, the bottom-plate 260 thickness is preferably optimized to allow maximum transparency and maximum thermal conductivity (since the temperature of the well contents is controlled by placing the plate bottom in contact with a temperature controlled surface). The thickness of the upper plate and bottom plate is in the range of 0.001 inches to 0.043 inches, with an additionally preferable thickness being on the order of 0.005 inches. The bottom-plate 260 thickness and material selection preferably yield transparency that is sufficient to allow visual inspection of the cells growing at the bottom of the wells 230. The bottom-plate 260 is preferably thin enough to resemble a plastic film that is then adhered to the bottom of the upper plate 220.

Sealingly-affixing the upper-plate 220 and the bottom-plate 260 together composes the assay plate 210. The resulting microplate prevents leakage of fluid from any of the wells, preventing both leakage from the plate and leakage between wells. The sealing method must also result in a construction that is stable to exposure to media, buffer and solvents typically used in the applications experiments. Plates can be expected to remain in contact with these fluids for several days, and it is required that the bonding method remain unchanged during this period. Conversely, the contents of the wells must in no way be changed by the sealing method. For example, adhesives used in the bonding process must be chosen carefully to avoid adverse effects on cell growth or cell responses during the assays.

According to one embodiment, an adhesive layer 240 is employed to both attach the upper-plate 220 to the bottom-plate 260 and also to provide sealing between the wells. The adhesive layer 240 preferably comprises die cut adhesive transfer tape (consisting of adhesive alone or adhesive-faced film) and/or curable adhesives (e.g., air curing cyanoacrylics or UV-curing materials) applied as a thin layer across the entire bonding surface and/or around each well. The chemical properties of the adhesive should be chosen so that there is no adverse effect on cell growth or the response of cells during the assay. The flexibility of the bottom plate 260 allows easy bonding of the bottom plate 260 to the upper plate 220 with adhesive.

In an alternative embodiments, the upper 220 and bottom 260 plates are sealingly-affixed using insert molding (or thermal bonding) or ultrasonic bonding. In the case of insert molding, the bottom plate 260 is placed inside an injection-molding machine and the top plate 220 is molded directly onto the bottom plate 260. The molten plastic bonds to the bottom plate 260 and then cools. In the case of ultrasonic bonding, the top 220 and bottom 260 plates are pressed together while high frequency vibrations create local melting and bonding between the plastics of the top 220 and bottom plates 260.

Through holes 215 formed in the upper-plate 220 form the wells 230 of the assay plate 210 when the upper-plate 220 is sealingly affixed to the bottom-plate 260. The through-holes 215 are preferably injection molded or machined in the upper-plate 220, and are typically cylindrical, rectangular, or conical in shape with diameters of approximately 1 mm to 28 mm. The diameter of the through holes 215 for a 96 well plate is more preferably 1 mm to 7 mm. Typically for injection molding, there is a slight draft of the holes 210 with the diameter at the top being slightly larger than the diameter at the bottom. The diameter is optimally chosen to conserve the amount of materials required to complete an assay and to minimize the well bottom surface area, thus minimizing the number of cells required in order to perform the assay. According to one preferred embodiment of the device, an assay plate 210 comprises one or more assay wells 230 or chambers (e.g., discrete locations on an assay plate surface where an assay reaction occurs and/or where an assay signal is emitted). Additional embodiments contain two or more, six or more, 24 or more, 96 or more, 384 or more, 1536 or more, or 9600 or more wells. According to one particular embodiment, the assay plate is a multi-well assay plate having a standard well configuration of 6 wells, 24 wells, 96 wells, 384 wells, or 1536 0wells.

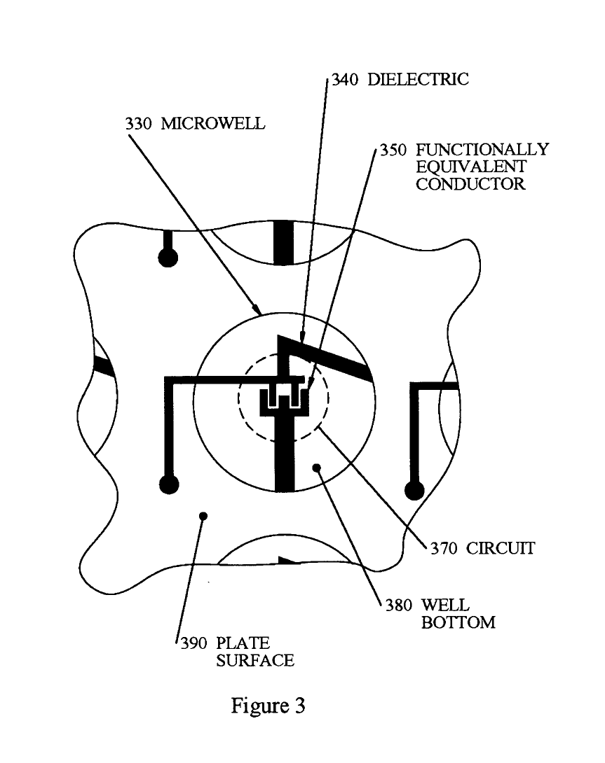

According to the device, a plurality of functionally equivalent conductors 250 in the form of impedance measuring electrodes is incorporated into each of the wells. The present device describes several novel configurations and materials for electrodes in multi-well sample plates. The impedance measuring electrodes 250 are formed in an array on the top surface of the bottom-plate 260 such that after the upper-plate 220 containing the through-holes 215 which comprise the well walls is sealingly-affixed to the bottom plate 260, the functionally equivalent electrodes 250 reside in the bottom of the formed wells 230. The plurality of impedance measuring electrodes 350, illustrated in FIG. 3, complete a circuit 310 in the bottom 380 of each micro-assay plate well 330 which allows the impedance changes during cell activation to be monitored. In contrast to the electrochemical sensors used in redox reactions in which oxidation occurs at the anode and reduction occurs at the cathode, the impedance-measuring electrodes of this device are not consumed and no oxidation or reduction occurs at the electrode surfaces. The electrodes are chemically inert. For the impedance measurements associated with this device, each of the conductors 350 is functionally equivalent, with cells on each of the electrodes contributing to the impedance changes that occur upon cellular activation.

The impedance-measuring electrodes 350 are formed of a single or multiple layer of a conductive material. The conductive material is preferably a metal or a non-metallic conductive material with a surface that is amenable to cell growth. Preferable metallic conductive materials include gold, silver, and platinum. Preferable non-metallic conductive materials include ITO, conducting polymers, and carbon fibers. Preferable conductive materials are inert to the organic and inorganic compounds typically used in biological assays and will not be subject to electrochemical reactions at the low voltages used in impedance measurements (100 mV).

The impedance-measuring electrodes 350 may be fabricated by a negative process of removing metal from a uniform layer across the substrate material. The uniform metal may be sputtered or evaporated using traditional sputtering or evaporating means on the surface of the bottom-plate, creating a thin film that is nanometers to microns in thickness. A preferred thickness is 50 nm. A 50 nm layer of gold is semi-transparent and allows the inspection of cells on the electrodes using common laboratory microscopes. Alternatively, the metal layer may be electroplated or laminated onto the surface of the bottom plate. After being applied, the uniform metal layer may be patterned to form the impedance-measuring electrodes using photolithographic exposure and chemical etching or alternatively, the metal may be removed by a laser ablation process. Metal that is not removed comprises the resulting electrodes.

Alternatively, the impedance-measuring electrodes 350 may be fabricated by the additive process of a printing process such as screen-printing or pad printing of a conductive ink. Conductive inks containing silver, gold, platinum, and/or carbon particles may be used for this purpose. Conductive inks from companies such as Dupont and Acheson are typical of those used. Gold is a preferable conductive material in that the particles are highly conductive and the gold is highly inert, making the surface of the electrodes resistant to degradation by the atmosphere and by fluids that may be used in the assay wells 330. Also, due to its inert nature, gold is not toxic to cells. Gold particles in the range of 0.25 to 10 microns may be used in inks that are applied to a thin layer to form the electrodes. Additionally, the electrodes may be formed from the combination of metal layers and conductive ink.

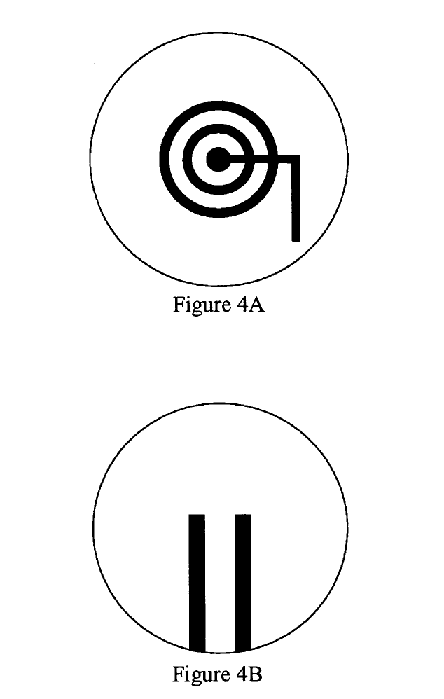

The dimensions of the electrode's 350 features are in the range of 5 microns to 3 millimeters, with 10 microns to 250 microns being a preferable range. Similarly, the spacing between the electrodes 350 may be from 5 microns to 3 millimeters, with a preferred range being 10 microns to 250 microns. Smaller spacing of the features is preferable as the electrical circuits formed by such spaced features are less sensitive to thermal and evaporative changes to the buffer used in the assays. Electrode geometries allowing the creation of an area of uniform electric field over the detection surface area at the bottom of the microplate are preferable. In one embodiment, the electrode geometry is an interdigitated finger structure with finger and gap widths that are comparable in dimension. Alternate geometries include simple designs with two opposing electrodes in the shape of lines or circles, as displayed in FIGS. 4.

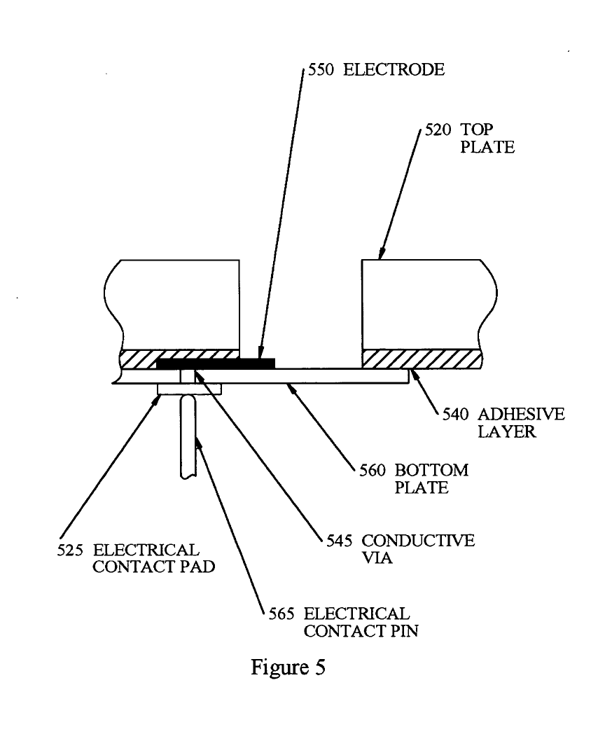

In order to provide for connections between the electrodes inside the wells and an impedance measuring system with which the plate will work in conjunction, the devices are provided with an array of electrically conductive electrical contact pads (or electrical contact pads) situated on the bottom surface of the bottom plate and an array of electrically conductive vias connecting these contact pads to the electrodes on the top surface of the bottom plate. As shown in FIG. 5 (an expanded view of a well side cross section), electrical contact with the impedance measuring system is made through electrical contact pins 565, that contact the device when the device is placed in an associated impedance measurement system. Electrical contact pads 525, situated on the bottom surface of the bottom plate 560, are round or oval targets of conductive material, such as sputtered gold or silver ink. The size of the pads is such that tolerances in the locations of the pins 565 and in the placement of the plate into the system will always ensure contact. The pads may be patterned onto the bottom plate 560 using the same processing steps used to pattern the electrodes 550 on the top surface of the bottom plate 560, i.e. sputtering and removal of gold, or screen printing of conductive ink, such as silver ink.

In order to make electrical contact between the electrical contact pad 525 and the electrodes 550, which are on opposite surfaces of the bottom plate 560, electrically conductive vias 545 are fabricated into the bottom plate 560. The vias 545 are created by first drilling an array of holes in the bottom plate 560. Drilling may be performed by conventional machining, by laser machining, or by ultrasonic drilling. Laser and ultrasonic drilling may be used in order to drill a bottom plate prepared from fragile material such as glass. For bottom plates 560 prepared from thin plastic films, laser drilling is a fast and convenient way of drilling holes on the order of 150 microns in diameter. After fabrication of the holes, the holes can be made into conductive vias 545 by coating or filling them with conductive material that contacts the electrodes 550 and electrical contact pads 525 on the opposite surfaces of the bottom plate 560. Additionally, the electrically conductive electrical contact pads and conductive vias may be formed from a combination of metal layers and conductive ink.

In one embodiment, in which sputtered gold is used to create both the electrodes 550 and pads 525, the holes are drilled before the sputtering process. In this way, sputtered gold can also coat the inner surfaces of the drilled holes, forming the conductive via. In another embodiment, in which the electrodes 550 and pads 325 are screen printed using conductive inks, the previously-drilled holes can be coated with the ink during the printing of these other features.

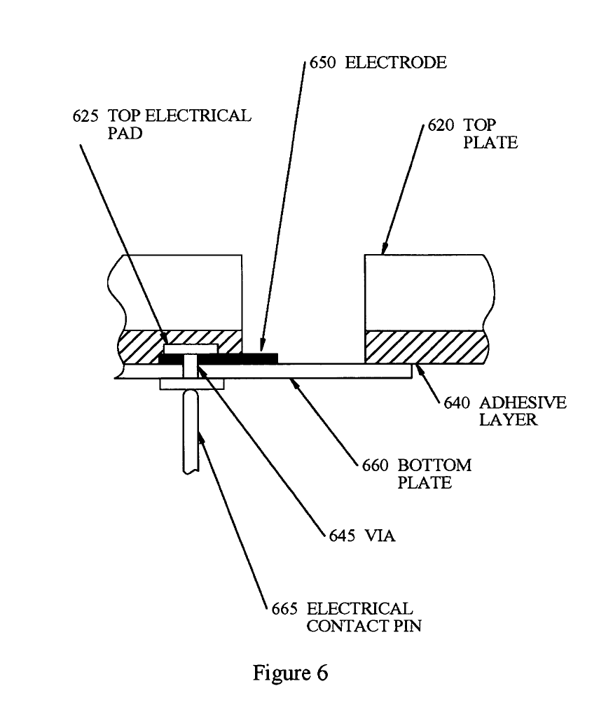

In the alternative embodiment illustrated in FIG. 6, the electrodes 650 are prepared from sputtered 50 nm gold, and the pads 625 are printed with conductive silver ink. An additional electrical pad 625 is added to the top surface of the bottom plate 660 in order to ensure that electrical continuity between the via 645 and the electrode 650 is made. In this embodiment, a top electrical conductive ink pad 625 is screen printed on the top surface of the bottom plate 660, intersecting both the drilled hole and the electrode 650. During this printing step, conductive ink also fills into the via hole 645. Ink printed to form the electrical contact pad 625 printed on the bottom surface of the bottom plate 660 thus makes contact with ink printed to form the top electrical pad 625.

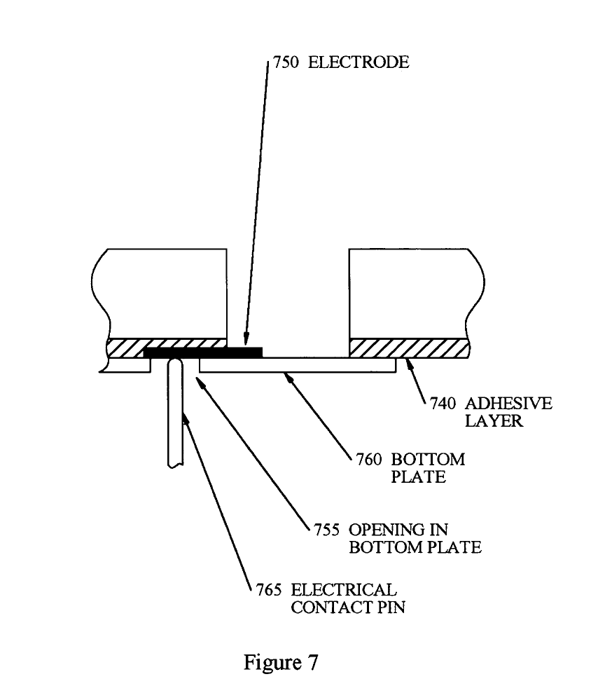

In an additional embodiment, electrical connection is made directly between the measurement system pins 765 and the bottom surface of the electrodes 750 as illustrated in FIG. 7. Drilled holes 755 in the bottom plate 760 allow access to the electrodes 750 by the measurement system pins 765. In this case, the electrode material must be robust enough to extend across the top of the hole 755 opening and to remain intact during the various stages of device fabrication. The holes 755 must be sized small enough in order to allow the electrode material to robustly cover the top of hole 755. Conversely, the holes 755 must be sized large enough as to allow alignment to and contact with the entire array of measurement system pins 765 accounting for the tolerances in the plate location in the instrument and the pin 765 locations in the instrument. For electrodes fabricated from 10 microns of conductive metal, hole diameters of 0.010″ to 0.080″ are suggested. Other, thicker or more robust electrodes materials, may allow larger holes to be covered. Conversely, thinner or less robust materials would only be used to cover smaller holes.

Making contact with the bottom surface of the microplate instead of connecting through the top of the wells or along the edge of the microplate offers distinct advantages. This configuration allows the area around the top of the plate to be free for access for injection of chemical compounds into the wells while measurements are being taken. Injection may be performed using a large pipetting head with an array of 96 or more pipetting tips. In addition, the large surface area available underneath the device allows for a much larger number of electrical connections to be made. This is important for two reasons. Firstly, it allows for the connection of increasing numbers of electrodes that would be incorporated into higher density microplates with 384, 864, 1536 or more wells. Secondly, connection of each individual electrode to a touchpad in this manner allows a homogeneous plate architecture where each well is electrically identical to every other well in the plate. This architecture allows the simultaneous measurement of an arbitrary number of wells simultaneously, limited only by the complexity of the impedance measurement electronics. Other devices described in the art, in order to reduce the number of electrical contacts, provide for common electrical contact with multiple electrodes; for example, an electrical bus may connect to all of the wells in each row of the device. With this strategy, however, there are two disadvantages. First, only one well per row can be measured at once without potential coupling or interferences between wells. Second, a problem with an electrical contact to a row would disable the entire row.

The bottom contact arrangement also ensures that, even for a device with a large number of connections, traces never need to cross in the microtiter plate. Thus, a single conductive layer can be fabricated on the bottom plate, keeping it simple and inexpensive to fabricate With this strategy, complex and expensive multi-layer electrical devices are required only in the to the impedance measuring instrument itself.

Insulating layers on top of the electrodes can be included in order to further define the exposed electrode geometry, to eliminate the electrical contribution of certain areas of the electrodes, and to facilitate the electrical connection to an associated impedance measurement system. In one example, it may be desired to concentrate the measurement solely in the center of the microtiter plate wells to reduce the amount of conductive material required to perform the assay and to reduce the overall manufacturing costs. For example, the use of gold in the well center is preferred, but the costs of gold makes its use as the entire conductive element prohibitive. Although the use of cheaper conductive materials, such as silver, may be desirable, the toxicity of silver may prohibit its use in the well center area. To facilitate the concentration of the measurement to the well center, a dielectric ink may be printed to mask the electrode areas outside of the well centers. In such an example, the electrodes may be fabricated from two conductive materials where the first material forms the part of the electrode that lies in the center of the well and that will be in contact with the assay contents while a second material forms a portion of the electrical path between the first material and the conductive via.

As an alternative to the device fabricated from an upper plate and a bottom plate, the device may be fabricated in one piece. A microtiter plate may be injection molded directly on to a conductive lead frame placed in the injection molding machine. The result from the insert molding process is an array of impedance measuring electrodes that are sealingly encapsulated by the injected plastic with exposed top surfaces of the electrodes residing at the bottom of the formed wells and the bottom surfaces of the electrodes exposed at the locations of electrical contact on the bottom of the microtiter plate. Portions of the lead frame that mechanically connect the array of electrodes together during the manufacturing process but are unnecessary from an electrical standpoint can be broken apart in a post processing step.

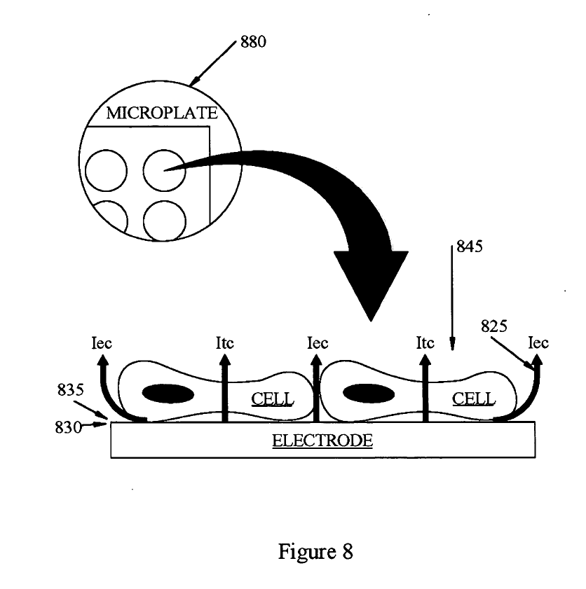

As displayed in FIG. 8, the electric field 825 generated by the electrodes 830 extends from the electrode surface 835 at the bottom of the well 880 to a depth equal roughly to the gap between the electrodes 830. Cells 845 that are growing on the bottom of the well 880 and on the electrodes 830 experience this electric field 825. Measurement of the total current in the circuit, comprised of the intracellular (Itc) and extracellular (lec) currents, allows calculation of the cell layer impedance by the impedance measurement system. In addition, non-adherent cells that have sedimented to the bottom of the wells and are within the electric field can additionally be assayed using this technology.

For the impedance measurement, which is performed with alternating voltage, a detector measures the current resulting from the applied alternating voltage. Both the magnitude of the resulting current and the phase (relative to the applied voltage) are part of the impedance, which is a complex number made up of real and imaginary components. The associated measurement system may measure both components or either. Typically, a 100 mV (rms) signal is applied and currents on the order of 0.1 to 1 mA (rms) are measured. The system (microtiter plate and associated impedance measurement system) should be designed to work with voltages as high as 300-400 mV. Essentially, the lower limit on the applied voltage is set by the amount of noise that can be tolerated. Voltages as low as 10-20 mV are more likely to be typical.

Typically, when identification of a particular microtiter assay plate is required in an assay system, bar code labels are applied to top or edges of the microplate. In the current device, it was desired to incorporate into the fabrication of the microplate itself a feature that would allow identification of the plate type to the assay system. This would obviate the need for a separate bar coding label and a separate bar code reader inside the instrument. In one embodiment, the plate identification can be accomplished by a number of mechanisms. Optically readable features, fabricated into the plate bottom at the same time as the electrical contact pads, could be read with a stationary reflective optical sensor as the plate moves into the assay system instrument. Electrically readable features, fabricated into the plate bottom at the same time as the electrical contact pads, could be read using the same electrical contact pins and electronics of the impedance measuring-system. Mechanical features on the upper plate such as holes, indentations, or steps could be read using optical or mechanical switches. RFID tags could be incorporated into the plate bottom or top which would be readable by a nearby unit inside the associated impedance measurement system. Another option for enabling plate ID allowing a larger amount of information to be stored and read is the incorporation of a microchip such as a PROM (Programmable read-only memory chip) or EEPROM (electronically erase-able programmable read-only memory chip). Each mechanism could additionally incorporate an error detecting code which would detect system errors before reading the plate.

The multi-well assay plates of the present device may be used with adherent and non-adherent cellular species, molecular species, viral particles, and bacteria, and may be used once or may be used multiple times. The assay plates are well suited to applications where the plates are disposable depending on the biological nature of the well inhabitants.

Applications

Impedance Measurement Instrument

The devices described in the examples below interface with a custom impedance measurement system in three ways. 1) The electrical contact pads on the bottom of the assembled device contact electrical contact pins on the instrument. Electrical connection of each well leads to an impedance measurement electronics. 2) The bottom surface of the device rests against a thermally controlled surface, allowing the temperature of the contents of the devices' wells to be controlled. 3) The wells of the top plate align with an automated pipetting device of the instrument, allowing the addition of different chemical compounds to be added to each of the wells during the impedance measurements.

Impedance measurements are comprised of impedance magnitude and impedance phase. Both of these quantities can be used to calculate the real part of the complex impedance. Comparing the impedance changes of different wells after the addition of the chemical compounds allows the determination of whether and to what degree the chemical compounds affect the cells.

### EXAMPLE 1

A bottom plate was fabricated from a 1 mm thick 122 mm×79 mm Borofloat™ glass substrate. Holes in the glass (0.030″) were drilled using an ultrasonic process. 1.6 microns of gold was sputtered onto both the top and bottom surfaces of the glass. At the same time, sputtered gold coated the inside surface of the drilled holes, forming an electrical via between to top and bottom surfaces of the glass. Photolithographic exposure and chemical etching techniques were then used to pattern the impedance measuring electrodes on the top surface of the bottom plate and to form the electrical contact pads on the bottom surface of the bottom plate. The electrodes were a pair of interdigitated finger combs with finger sizes of 30 microns in width and 2.5 mm in length. Gaps between the fingers on opposing combs were 30 microns.

The bottom plate was bonded using UV curable epoxy to a machined polystyrene upper plate containing 96 through holes in an 8×12 array. The 96 holes, each 6 mm in diameter and 12 mm deep, were aligned on top of the electrode features on the bonded bottom plate in order to form 96 wells.

Into each well of the 96-well device, 40,000 CHO cells transfected with the ml-muscarinic receptor were pipetted added along with 150 uL growth media. The device was placed in an incubator at 37 C and 5% CO₂ environment for 18 hours in order to allow the cells to settle to the bottom of the wells and to attach and grow across the surface of the well bottom and electrode. Prior to performing the cell response experiment, the growth media was removed and was replaced with 136 mM Hanks Hepes buffer with 0.1% BSA. Six antagonist titrations, with decreasing concentration from left to right, were added from Row A to Row F (inclusive) and allowed to incubate for 15 minutes. To Rows G and H were added the negative control (matching buffer). The device was placed into the impedance measurement system and allowed to thermally equilibrate to the system at 28 C. After the 15-minute incubation, a single concentration of agonist (carbachol) was added to Rows A-G, while a negative control (matching buffer) was added to Row H. Impedances of each device were measured for 5 minutes prior to and 10 minutes after agonist addition at 20-second intervals.

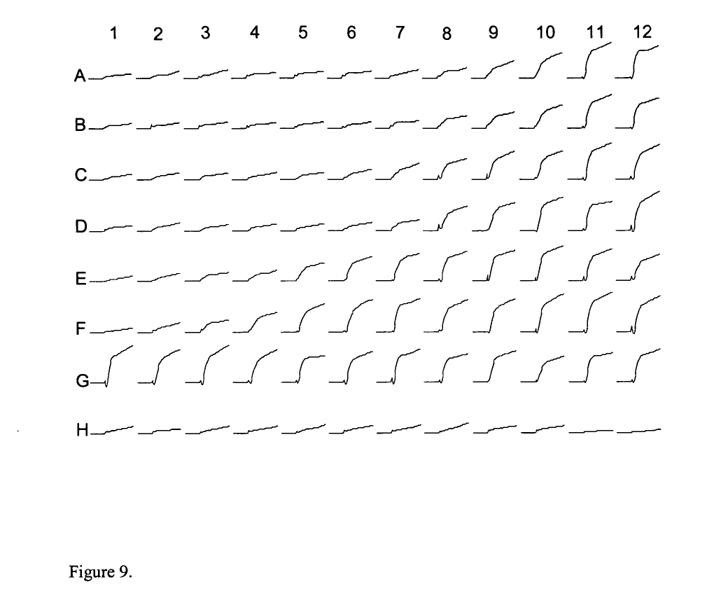

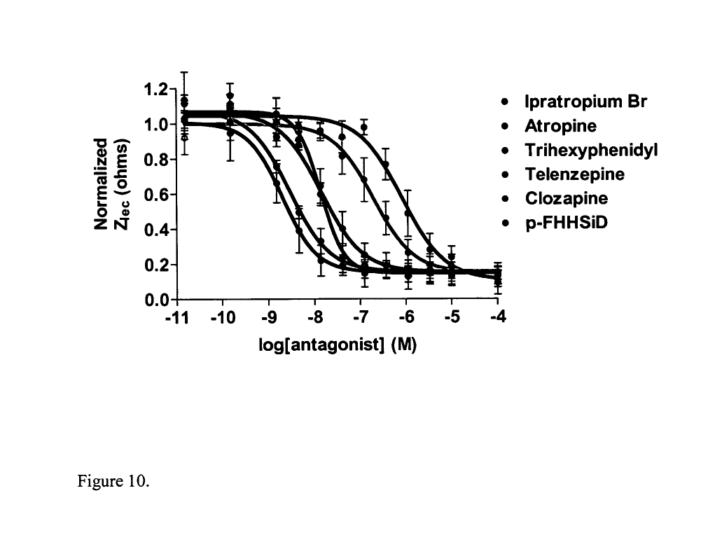

In FIG. 9, the impedance measurements of the 96 wells are shown as a function of time. It can be seen how decreased antagonist concentration gives larger cell impedance changes. In FIG. 10, responses were graphed as a function of antagonist concentration to determine the IC₅₀ of each antagonist, showing the relative potencies of the different antagonists.

### EXAMPLE 2

A bottom plate was fabricated from a 1 mm thick 122 mm×79 mm polystyrene sheet substrate. Holes in the polystyrene (0.030″) were drilled. 0.5 microns of gold was sputtered onto the top surface of the polystyrene through a thin metal mask or stencil in order to create the electrode pattern. The electrodes were a pair of interdigitated finger combs with finger sizes of 200 microns in width and 1.5 mm in length. Gaps between the fingers on opposing combs were 200 microns. At the same time as the electrodes were created, sputtered gold coated the inside surface of the drilled holes. Subsequently, 0.5 microns of gold was sputtered onto the bottom surface of the polystyrene through a thin metal mask or stencil in order to create the electrical contact pad pattern. At the same time, sputtered gold again coated the inside surface of the drilled holes, forming an electrical via between to top and bottom surfaces of the polystyrene. After fabrication of the gold features on the polystyrene, the bottom plate was plasma etched in order to increase the adherence of cells onto the surface.

The bottom plate was bonded using UV curable epoxy to a machined polystyrene upper plate containing 96 through holes in an 8×12 array. The 96 holes, each 6 mm in diameter and 12 mm deep, were aligned on top of the electrode features on the bonded bottom plate in order to form 96 wells.

50,000 HeLa cells per well were pipetted into the wells of the device in 150 microliters MEM growth media. The cells in the device were incubated overnight in an incubator at 37 C and 5% CO2. The following day, the media was removed and the cells gently washed 3 times with 136 mM Hanks Hepes buffer. The final fluid exchange introduced 135 microliters of 136 mM Hanks Hepes buffer with 0.1% BSA. The device was introduced into impedance measurement instrument, where it was warmed to 28 C. 30 minutes after the media to buffer exchange, impedance measurements were begun. After 5 minutes of pre-drug addition impedance measurement, a panel of chemical compounds was added to the cells in the device. The source of the panel was a 96 well plate containing 92 different chemical compounds. The remaining 4 wells contained buffer only.

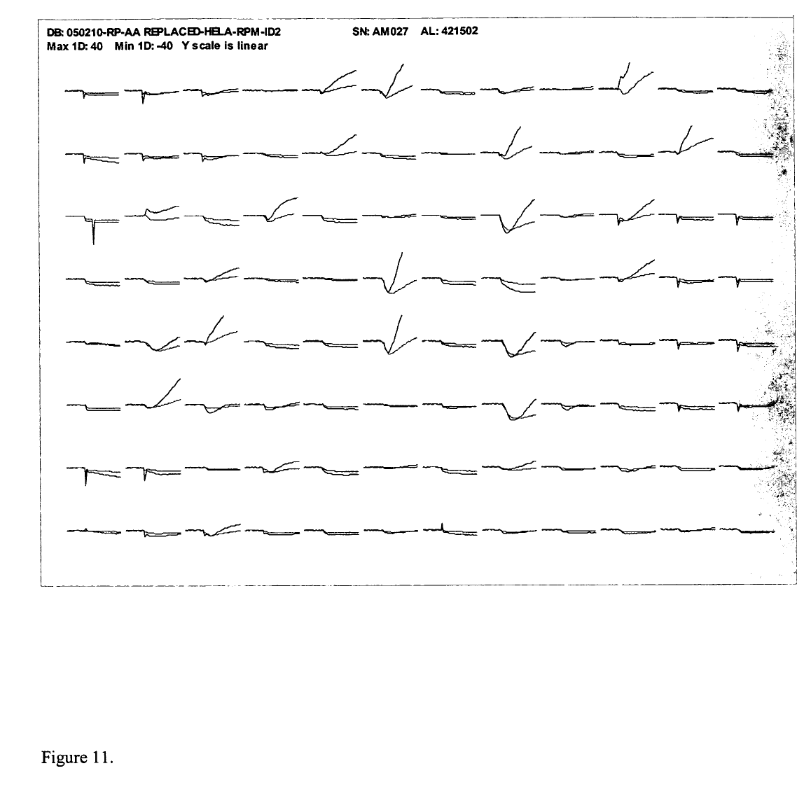

In FIG. 11, the impedance measurements of the 96 wells are shown. It can be easily be seen that responses of the cells to the different chemical compounds can be characterized both by the magnitude of the impedance changes as well as the kinetics and direction of the impedance responses.

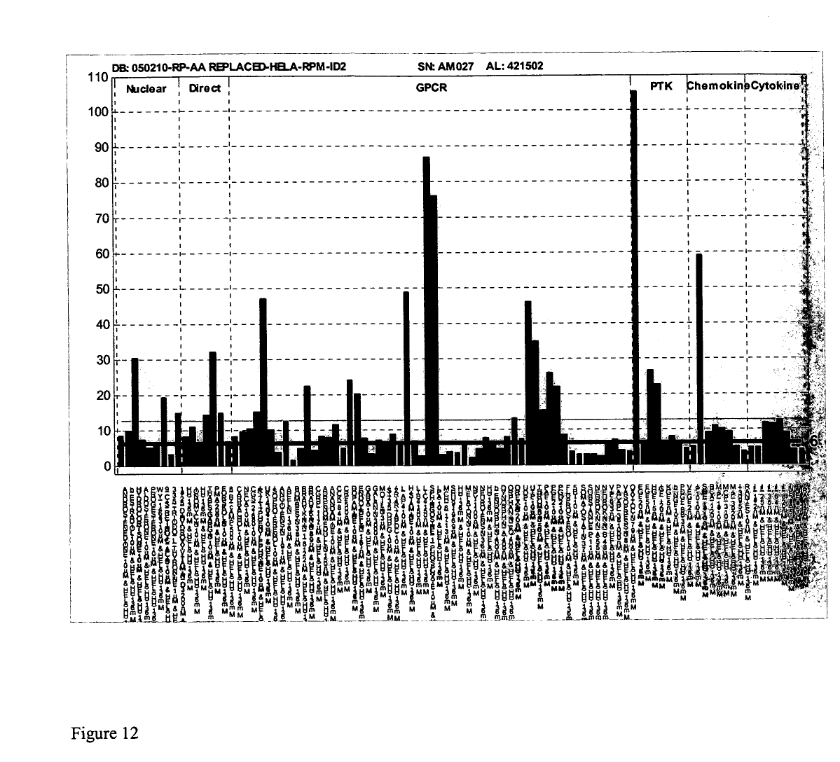

In FIG. 12, the magnitude of the responses from each of the compounds is compared in a histogram format.

### EXAMPLE 3

Bottom plates were fabricated from a 0.005″ thick polyester sheet substrate. Holes in the polystyrene (0.15 mm) were laser drilled in a pattern to match with the electrical vias to be created in a later step in the bottom plate. Conductive silver ink was used in a screen printing process to create the electrical contact pads on the bottom surface of the bottom plate material and to fill into the drilled via holes. Subsequently, a second printing pass with silver ink was used to print features on the top surface of the bottom plate, leading from the drilled vias towards a location near where the center of the microplate wells will be created when the bottom plate and upper plate are bonded. Subsequently, fingers of gold ink were printed creating an interdigitated finger pattern between the two silver leads. Each gold finger overlapped on one end with one of the silver leads. In the last printing step, a dielectric ink was printed, covering the entire surface top surface of the bottom plate except a rectangle that left lengths of the gold fingers exposed. By covering the tips of the gold fingers with insulating dielectric, the total length of exposed gold finger was determined by the dimension of the dielectric window and the finger widths. The printed bottom plate material was plasma etched for 4 minutes in an oxygen atmosphere in order to increase cell adhesion. Following etching, individual bottom plates were cut from the sheet.

Each bottom plate was bonded using 0.002″ adhesive transfer tape to an injection molded polystyrene upper plate containing 96 through holes in an 8×12 array. The 96 holes, each 6.55 mm in diameter, were aligned on top of the electrode features on the bonded bottom plate in order to form 96 wells.

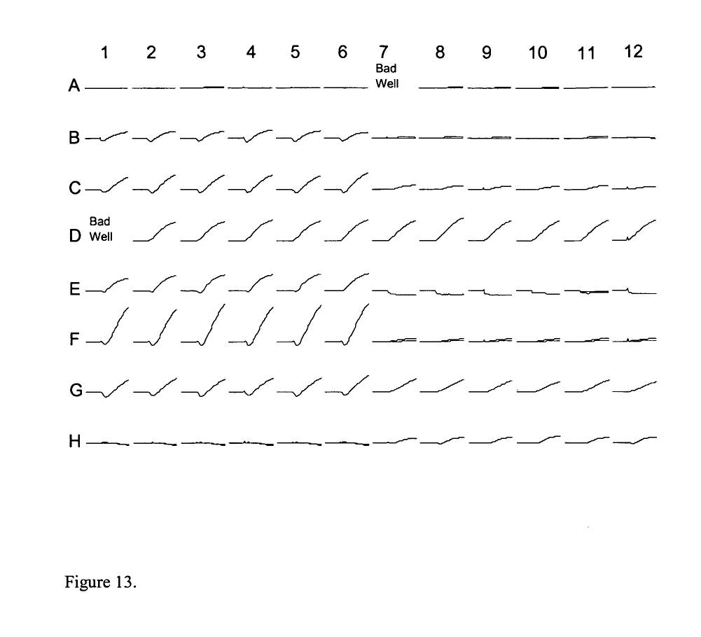

Into each well of the 96-well device, 50,000 HeLa cells were pipetted added along with 150 uL growth media. The device was placed in an incubator at 37 C and 5% CO2 environment for 18 hours in order to allow the cells to settle to the bottom of the wells and to attach and grow across the surface of the well bottom and electrode. Prior to performing the cell response experiment, the growth media was removed and was replaced with 136 mM Hanks Hepes buffer with 0.1% BSA. The device was placed into the impedance measurement system and allowed to thermally equilibrate to the system at 28 C. A panel of 14 ligands with 6 replicates each was added to seven rows (B through H) of the device with 2 ligands per row. To Row A was added the negative control (buffer). Impedances of each device were measured at 20 second intervals for 5 minutes prior to and 10 minutes after ligand addition. In FIG. 13, the impedance changes with time for each well are plotted. Similar response kinetics and characteristics can be grouped together (e.g., D01-D06, D06-12, and E01-06 appear similar) indicating that cellular responses to these ligands are related. Two electrically open wells did not provide meaningful data as noted by the impedance measurement system (wells D01 and A07).

### SUMMARY

While the above is a complete description of possible embodiments of the device, various alternatives, modifications, and equivalents may be used. For instance a person skilled in the art will appreciate that the impedance measuring electrode geometry is not limited to an interdigitated finger design. Other conductor geometries may alternatively be used. Further, all publications and patent documents recited in this application are incorporated by reference in their entirety for all purposes to the same extent as if each individual publication and patent document was so individually denoted. The above description should be view as only exemplary embodiments of the device, the boundaries of which are appropriately defined by the metes and bounds of the following claims.

1. A multiwell impedance measurement device comprising:
A. a plurality of chambers for containing separated samples in a planar array configuration,
Said chambers having a bottom surface and said chambers being formed from an upper plate containing a plurality of through holes and a bottom plate,
Said bottom plate having a top surface and a bottom surface,
Said upper plate having a top surface and a bottom surface
Said top surface of said bottom plate being sealingly affixed to said bottom surface of said upper plate.
B. A plurality of functionally equivalent impedance measuring electrodes lying flat on said bottom surface of each of said plurality of chambers and on said top surface of said bottom plate, said electrodes exposed to said samples, wherein each of said electrodes is electrically insulated from each of the other electrodes in the device, said electrodes having a top surface and a bottom surface.
C. Connection means for making electrical contact with each of said electrodes from said bottom surface of said bottom plate.

2. The multiwell impedance device of claim 1 wherein said samples are liquid.

3. The multiwell impedance device of claim 1 wherein said samples are solid.

4. The multiwell impedance device of claim 1 wherein said samples are biological compounds.

5. The multiwell impedance device of claim 1 wherein said samples are molecular.

6. The multiwell impedance measurement device of claim 1 wherein said through holes are cylindrical.

7. The multiwell impedance measurement device of claim 1 wherein said through holes are square.

8. The multiwell impedance measurement device of claim 1 wherein said through holes are conical.

9. The multiwell impedance measurement device of claim 1 wherein said upper and bottom plates are made from plastics, elastomers, ceramics, composites, glass, carbon materials, or a combination of any of these materials.

10. The multiwell impedance measurement device of claim 9 wherein said plastic may be polystyrene, polycarbonate, polyamide, polyimide, polyethylene, polypropylene, polyethylene terephthalate, cyclo-olefinpolymer, or polyester.

11. The multiwell impedance measurment device of claim 9 wherein said plastic is any injection moldable plastic.

12. The multiwell impedance measurement device of claim 1 wherein said bottom plate is transparent.

13. The multiwell impedance measurement device of claim 1 wherein said planar array consists of 24 wells.

14. The multiwell impedance measurement device of claim 1 wherein said planar array consists of 96 wells.

15. The multwell impedance measurement device of claim 1 wherein said planar array consists of 384 wells.

16. The multiwell impedance measurement device of claim 1 wherein said planar array consists of 864 wells.

17. The multiwell impedance measurement device of claim 1 wherein said planar array consists of 1536 wells.

18. The multiwell impedance measurement device of claim 1 wherein said plurality of functionally equivalent impedance measuring electrodes consist of two identical electrodes.

19. The functionally equivalent electrodes of claim 1 wherein said electrodes are formed from conductive material deposited onto the surface of said bottom plate via electroplating, sputtering, evaporating, screenprinting, or pad printing.

20. The functionally equivalent electrodes of claim 1 wherein said conductive material is gold, silver, indium tin oxide, copper, or carbon fibers, copper.

21. The functionally equivalent electrodes of claim 1 wherein said electrodes are formed of a single layer of a conductive material.

22. The functionally equivalent electrodes of claim 1 wherein said electrodes are formed from multiple layers of conductive materials.

23. The multiwell impedance measurement device of claim 1 wherein said process of sealingly affixing the upper plate to the bottom plate is achieved with an adhesive layer, thermal bonding, or ultrasonic bonding.

24. The multiwell impedance device of claim 1 wherein the connection means for making electrical contact with each of said electrodes from said bottom surface of said bottom plate comprises electric contact pads formed on said bottom surface of said bottom plate and electrically conductive vias connecting said contact pads to the electrodes on said top surface of said bottom plate.

25. The electrical contact pads of claim 24 wherein said pads are formed from conductive material deposited onto said bottom surface of said bottom plate via electroplating, sputtering, evaporating, screenprinting, or pad printing.

26. The electrical contact pads of claim 25 wherein said conductive material is gold, silver, indium tin oxide, copper, or carbon fibers.

27. The electrical contact pads of claim 24 wherein said contact pads are formed from conductive particles applied as a conductive ink.

28. The electrical contact pads of claim 27 wherein said conductive particles are made from gold, silver, platinum, or carbon.

29. The multiwell impedance measurement device of claim 1 wherein said impedance measuring electrodes are formed from conductive particles applied as a conductive ink.

30. The multiwell impedance measurement device of claim 29 where said conductive particles are made from gold, silver, platinum, or carbon.

31. The multiwell impedance measurement device of claim 1 wherein said electrodes are formed from metal layers and conductive ink.

32. The multiwell impedance measurement device of claim 24 wherein said conductive vias are formed from metal layers and conductive ink.

33. The multiwell impedance measurement device of claim 24 wherein said electrical contact pads are formed from metal layers and conductive ink.

34. The multiwell impedance measurement device of claim 1 additionally comprising a means for instrument readable plate identification.

35. The multiwell impedance measurement device of claim 34 wherein said means for instrument readable plate identification comprises optically readable features, electrically readable features, mechanical features, RFID tags, or a memory chip.

36. A multiwell impedance measurement device comprising:
A. a plurality of chambers for containing separated samples in a planar array configuration,
Said chambers having a bottom surface and said chambers being formed from a plate containing a plurality of holes extending partially through said plate.
B. A plurality of functionally equivalent impedance measuring electrodes lying flat on said bottom surface of each of said plurality of chambers, said electrodes exposed to said samples, wherein each of said electrodes is electrically insulated from each of the other electrodes in the device, said electrodes having a top surface and a bottom surface, said plate being formed around said electrodes.
C. Connection means for making electrical contact with said electrodes from said bottom surface of said plate.

37. The multiwell impedance device of claim 36 wherein said samples are liquid.

38. The multiwell impedance device of claim 36 wherein said samples are solid.

39. The multiwell impedance device of claim 36 wherein said samples are biological compounds.

40. The multiwell impedance device of claim 36 wherein said samples are molecular.

41. The multiwell impedance measurement device of claim 36 wherein said holes are cylindrical.

42. The multiwell impedance measurement device of claim 36 wherein said holes are square.

43. The multiwell impedance measurement device of claim 36 wherein said holes are conical.

44. The multiwell impedance measurement device of claim 36 wherein said plate is made from plastics, elastomers, ceramics, composites, glass, carbon materials, or a combination of any of these materials.

45. The multiwell impedance measurement device of claim 44 wherein said plastic may be polystyrene, polycarbonate, polyamide, polyimide, polyethylene, polypropylene, polyethylene terephthalate, cyclo-olefinpolymer, or polyester.

46. The multiwell impedance measurment device of claim 44 wherein said plastic is any injection moldable plastic.

47. The multiwell impedance measurement device of claim 36 wherein said plate is transparent.

48. The multiwell impedance measurement device of claim 36 wherein said planar array consists of 24 wells.

49. The multiwell impedance measurement device of claim 36 wherein said planar array consists of 96 wells.

50. The multwell impedance measurement device of claim 36 wherein said planar array consists of 384 wells.

51. The multiwell impedance measurement device of claim 36 wherein said planar array consists of 864 wells.

52. The multiwell impedance measurement device of claim 36 wherein said planar array consists of 1536 wells.

53. The multiwell impedance measurement device of claim 36 wherein said plurality of functionally equivalent impedance measuring electrodes consist of two identical electrodes.

54. The functionally equivalent electrodes of claim 36 wherein said electrodes are formed by the deposition of a conductive material onto a frame via sputtering, evaporating, screenprinting, or pad printing.

55. The functionally equivalent electrodes of claim 54 wherein said plate is molded onto said frame.

56. The functionally equivalent electrodes of claim 36 wherein said conductive material contains gold, silver, indium tin oxide, or carbon fibers.

57. The functionally equivalent electrodes of claim 36 wherein said electrodes are formed of a single layer of a conductive material.

58. The functionally equivalent electrodes of claim 36 wherein said electrodes are formed from multiple layers of a conductive material.

59. The multiwell impedance device of claim 36 wherein the connection means for making electrical contact with each of said electrodes from said bottom surface of said plate comprises electric contact pads situated on said bottom surface of said plate and electrically conductive vias connecting said contact pads to the electrodes on said top surface of said plate.

60. The electrical contact pads of claim 59 wherein said pads are formed from conductive material deposited onto said bottom surface of said bottom plate via electroplating, sputtering, evaporating, screenprinting, or pad printing.

61. The electrical contact pads of claim 60 wherein said conductive material is gold, silver indium tin oxide, copper, or carbon fibers.

62. The electrical contact pads of claim 59 wherein said contact pads are formed from conductive particles applied as a conductive ink.

63. The electrical contact pads of claim 62 wherein said conductive particles are made from gold, silver, platinum, or carbon.

64. The multiwell impedance measurement device of claim 36 wherein said electrodes are formed from conductive particles applied as a conductive ink.

65. The multiwell impedance measurement device of claim 64 where said conductive ink is made from gold, silver, platinum, indium tin oxide, polymers, or carbon.

66. The multiwell impedance measurement device of claim 36 wherein said electrodes are formed from metal layers and conductive ink.

67. The multiwell impedance measurement device of claim 59 wherein said conductive vias are formed from metal layers and conductive ink.

68. The multiwell impedance measurement device of claim 59 wherein said electrical contact pads are formed from metal layers and conductive ink.

69. The multiwell impedance measurement device of claim 36 additionally comprising a means for instrument readable plate identification.

70. The multiwell impedance measurement device of claim 69 wherein said means for instrument readable plate identification comprises optically readable features, electrically readable features, mechanical features, RFID tags, or a memory chip.

71. A multiwell impedance measurement device comprising:
A. a plurality of chambers for containing separated samples in a planar array configuration,
Said chambers having a bottom surface and said chambers being formed from an upper plate containing a plurality of through holes and a bottom plate,
Said bottom plate having a top surface and a bottom surface,
Said upper plate having a top surface and a bottom surface
Said top surface of said bottom plate being sealingly affixed to said bottom surface of said upper plate.
B. A plurality of functionally equivalent impedance measuring electrodes lying flat on said bottom of each of said plurality of chambers and on said top surface of said bottom plate, said electrodes exposed to said samples, wherein each of said electrodes is electrically insulated from each of the other electrodes in the device, said electrodes having a top surface and a bottom surface.
C. Connection means for making electrical contact with each of said electrodes from said bottom surface of said bottom plate.
D. A means for instrument readable plate identification.

72. The multiwell impedance device of claim 71 wherein said samples are liquid.

73. The multiwell impedance device of claim 71 wherein said samples are solid.

74. The multiwell impedance device of claim 71 wherein said samples are biological compounds.

75. The multiwell impedance device of claim 71 wherein said samples are molecular.

76. The multiwell impedance measurement device of claim 71 wherein said through holes are cylindrical.

77. The multiwell impedance measurement device of claim 71 wherein said through holes are square.

78. The multiwell impedance measurement device of claim 71 wherein said through holes are conical.

79. The multiwell impedance measurement device of claim 71 wherein said upper and bottom plates are made from plastics, elastomers, ceramics, composites, glass, carbon materials, or a combination of any of these materials.

80. The multiwell impedance measurement device of claim 79 wherein said plastic may be polystyrene, polycarbonate, polyamide, polyimide, polyethylene, polypropylene, polyethylene terephthalate, cyclo-olefinpolymer, or polyester.

81. The multiwell impedance measurment device of claim 79 wherein said plastic is any injection moldable plastic.

82. The multiwell impedance measurement device of claim 71 wherein said bottom plate is transparent.

83. The multiwell impedance measurement device of claim 71 wherein said planar array consists of 24 wells.

84. The multiwell impedance measurement device of claim 71 wherein said planar array consists of 96 wells.

85. The multwell impedance measurement device of claim 71 wherein said planar array consists of 384 wells.

86. The multiwell impedance measurement device of claim 71 wherein said planar array consists of 864 wells.

87. The multiwell impedance measurement device of claim 71 wherein said planar array consists of 1536 wells.

88. The multiwell impedance measurement device of claim 71 wherein said plurality of functionally equivalent impedance measuring electrodes consist of two identical electrodes.

89. The functionally equivalent electrodes of claim 71 wherein said electrodes are formed by the deposition of a conductive material onto the surface of said bottom plate via sputtering, evaporating, screenprinting, or pad printing.

90. The functionally equivalent electrodes of claim 71 wherein said conductive material is gold, silver, indium tin oxide, or carbon fibers.

91. The functionally equivalent electrodes of claim 71 wherein said electrodes are formed of a single layer of a conductive material.

92. The functionally equivalent electrodes of claim 71 wherein said electrodes are formed from multiple layers of a conductive material.

93. The multiwell impedance measurement device of claim 71 wherein said process of sealingly affixing the upper plate to the bottom plate is achieved with an adhesive layer, thermal bonding, or ultrasonic bonding.

94. The multiwell impedance device of claim 71 wherein the connection means for making electrical contact with each of said electrodes from said bottom surface of said bottom plate comprises electric contact pads situated on said bottom surface of said bottom plate and electrically conductive vias connecting said contact pads to the electrodes on said top surface of said bottom plate.

95. The electrical contact pads of claim 94 wherein said pads are formed from conductive material deposited onto said bottom surface of said bottom plate via electroplating, sputtering, screenprinting, or pad printing.

96. The electrical contact pads of claim 95 wherein said conductive material is gold, silver, indium tin oxide, copper, or carbon fibers.

97. The electrical contact pads of claim 94 wherein said contact pads are formed from conductive particles applied as a conductive ink.

98. The electrical contact pads of claim 97 wherein said conductive particles are made from gold, silver, platinum, or carbon.

99. The multiwell impedance measurement device of claim 71 wherein said electrodes are formed from conductive particles applied as a conductive ink.

100. The multiwell impedance measurement device of claim 99 where said conductive ink is made from gold, silver, platinum, indium tin oxide, polymers, or carbon.

101. The multiwell impedance measurement device of claim 71 wherein said electrodes are formed from metal layers and conductive ink.

102. The multiwell impedance measurement device of claim 94 wherein said conductive vias are formed from metal layers and conductive ink.

103. The multiwell impedance measurement device of claim 94 wherein said electrical contact pads are formed from metal layers and conductive ink.

104. The multiwell impedance measurement device of claim 71 wherein said means for plate identification comprises optically readable features, electrically readable features, mechanical features, RFID tags, or a memory chip.
